(19) United States
(12) Patent Application Publication
(10) Pub. No.: US 2021/0313131 A1
(43) Pub. Date: Oct. 7, 2021

(54) RELAY MODULE

(71) Applicant: Phoenix Contact GmbH & Co. KG, Blomberg (DE)

(72) Inventors: Stefan BENK, Bad Pyrmont (DE); Ralf HOFFMANN, Berlin (DE); Christian ADAM, Hirzlei (DE)

(21) Appl. No.: 17/274,733

(22) PCT Filed: Aug. 26, 2019
(86) PCT No.: PCT/EP2019/072694

§ 371 Date: Mar. 9, 2021

(30) Foreign Application Priority Data
Sep. 12, 2018 (BE) BE2018/5624

(51) Int. Cl. H01H 47/04; H01H 47/22; H01H 47/00; H01H 3/02

(52) U.S. Cl. CPC H01H 47/04; H01H 3/022; H01H 47/005; H01H 47/226

(57) ABSTRACT

The disclosure relates to an electromagnetic relay module, comprising a first circuit branch comprising a first capacitor and a first relay connected in series with the first capacitor, a second circuit branch comprising a second capacitor and a second relay connected in series with the second capacitor, a switching element which is arranged between the first circuit branch and the second circuit branch and comprises a first switching state and a second switching state. In the first switching state of the switching element the first circuit branch and the second circuit branch are arranged in a parallel connection. In the second switching state of the switching element the first relay and the second relay are arranged in a series connection. The switching element is configured to change from the first switching state to the second switching state in the switch-on process of the relay module

### CROSS-REFERENCE TO RELATED APPLICATIONS

The present application is the national phase entry under 35 U.S.C. 371 of International Patent Application No. PCT/EP2019/072694 by Benk et al., entitled “RELAY MODULE,” filed Aug. 26, 2019, and claims the benefit of Belgian Patent Application No. BE2018/5624 by Benk et al., entitled “RELAISMODUL,” filed Sep. 12, 2018, each of which is assigned to the assignee hereof and is incorporated by reference in its entirety.

### FIELD OF THE DISCLOSURE

The present disclosure relates to a relay module, in particular an electromagnetic relay module, and an arrangement with an electromagnetic relay module.

### BACKGROUND

In the case of electromagnetic relays, there is the problem of heating due to the high coil currents that are used to attract the armature from an open position to a holding position, to close the relay. A minimum response surge is used to tighten the armature. To hold the anchor in the closed state, a lower holding flow rate is used in comparison to this. Since a stronger magnetic field and thus a greater magnetic flow through the excitation coil is used for attraction than for holding the armature in the holding position, solutions are desirable to reduce the magnetic flow through the excitation coil after the armature has been tightened in the holding position and for the period of time in which the armature is held in the holding position, and thus to reduce the power and consequently the heating of the relay, for the period in which the relay is kept closed. In some examples, pulse width modulation (PWM) is applied to the supply voltage to reduce the coil current to an advantageous value for the desired period of time. However, complex microelectronic components and correspondingly complex switching architectures are used for PWM control. The PWM can also have electromagnetic effects on the environment, which can be undesirable.

### SUMMARY

An improved concept for a relay module is described herein.

The improved relay module is achieved by the subject matter of the independent claims. Advantageous aspects of the disclosure are the subject matter of the dependent claims, the description and the accompanying figures.

The improved relay module enables reducing the coil current by an increase of the total resistance of the relay module after the relay has fully tightened, in particular the relay coils of both relays of the relay module, with an unchanged supply voltage, in particular constant and stable applied voltage, and thus to reduce the relay power or the electrical power and thus the heat generation or the heat dissipation.

According to a first aspect, the object is achieved by an electromagnetic relay module, comprising: a first circuit branch comprising a first capacitor and a first relay connected in series with the first capacitor, a second circuit branch comprising a second capacitor and a second relay connected in series with the second capacitor, a switching element which is arranged between the first circuit branch and the second circuit branch and comprises a first switching state and a second switching state, wherein in the first switching state of the switching element the first circuit branch and the second circuit branch are arranged in a parallel connection, and wherein in the second switching state of the switching element the first relay and the second relay are arranged in a series connection, and wherein the switching element is configured to change from the first switching state to the second switching state in the switch-on process of the relay module to increase the total resistance of the relay module.

This has the technical advantage that a relay module can be provided whose coil power of the first relay or second relay is automatically reduced from a pull-in power, which may be provided to respectively attract the armature from an open position to the holding position, to a lower holding power, which may be applied to hold the armature in the holding position, as soon as the first armature and the second armature are fully tightened in the holding position. The holding position of the relay module can be defined in such a way that the first armature of the first relay and the second armature of the second relay are closed, i.e. both relays have pulled through completely.

The configuration of the present relay module with two interconnected relays enables the total resistance of the relay module to be changed, in particular to be increased, by converting the circuit arrangement of the two relays from a parallel circuit to a series circuit of the relays.

By switching the parallel connection of the first circuit branch and the second circuit branch into the series connection of the first relay and the second relay, the total resistance of the relay module, in particular a combination of the first relay and the second relay, is increased.

With the supply voltage unchanged, the increase in the total resistance of the serially connected first relay and second relay in turn leads to a reduction in the coil currents flowing through the first relay and the second relay. A reduced coil current in turn leads to a reduction in the magnetic flow through the respective relay and, associated therewith, to a reduction of the magnetic field in the respective relay.

Due to the low resistance of the first capacitor and the second capacitor for the period in which the switching element is in the first switching state, the first and second circuit branches are arranged in parallel and the first capacitor and the second capacitor are charged, resistors of the first capacitor and of the second capacitor are negligible for the determination of the total resistance for this period.

The first capacitor and the second capacitor are in turn dimensioned such that a complete charge of the first capacitor and the second capacitor corresponds to a complete tightening of the armatures in the holding position. The dimensioning can depend on the operating voltage, the coil resistance, i.e. the internal resistance, and the inductance. In this way, the flow to reach the working state of the relay module can be guaranteed. The capacitors and components of the switching element can be configured in such a way that the switching occurs without an additional switching pulse. The holding value is typically at 50%, conservatively at 60% of the nominal voltage. If the coil voltage is zero again, the switching element switches again from the second switching state to the first switching state.

By reducing the flow and thus reducing the respective coil power of each relay, a reduction in the heat generated by the relay is achieved. Particularly in the case of components with a small overall size, a reduction in heat generation is advantageous due to the low heat capacity of the components.

In one example, the relay module comprises a holding position in which a first armature is attracted by the first relay and in which a second armature is attracted by the second relay, and wherein the switching element is configured to change from the first switching state to the second switching state as soon as the relay module has taken a stop position.

Tightening the armatures uses a higher flow, especially an initial flow, than holding the armatures by the respective relay. A higher power is therefore used to tighten the armatures than to hold the armatures. After tightening the armatures the flow of the coils of the relay can thus be reduced. The switching time of the switching element can therefore be selected so that switching to the series connection of the relays takes place as soon as both armatures are attracted. The current is reduced with the same voltage due to the increased total resistance and the power used is therefore also reduced.

In one example, the first capacitor is configured to provide a first charging current to the first relay in the first switching state of the switching element, and the second capacitor is configured to provide a second charging current to the second relay in the first switching state of the switching element, the first charging current being suitable for causing an attraction and holding of the first armature, and wherein the second charging current is suitable to cause an attraction and holding of the second armature.

The charging current of the capacitors can be sufficient to switch the relays. This means that the charging current of the capacitors is sufficient to provide the initial flow for the respective relay. The capacitors can be used to set a switching point in time for the switching element that switches when both armatures are attracted.

In one example, the relay module can be electrically connected to a voltage source which is configured to provide a constant voltage, wherein the first circuit branch and the second circuit branch can be connected to the voltage source.

The voltage source can be a DC voltage source that provides a constant voltage. The voltage can be, for example, 12V or 24V and thus operate both relays with a corresponding voltage value. The voltage can also have other values. The level of the voltage can depend on an application of the relay module. The voltage source can reduce the current when switching over to the series circuit due to the then increased total resistance.

In one example, the first capacitor provides the first charging current and the second capacitor provides the second charging current, when the constant voltage is applied to the first circuit branch and to the second circuit branch.

The first capacitor and the second capacitor are charged when the constant voltage is applied. The voltage on the capacitors increases. The charging current decreases over time. However, the charging current is sufficient to switch the relays.

In one example, the first switching state of the switching element comprises a higher resistance of the switching element compared to the resistance of the switching element in the second switching state and the second switching state of the switching element comprises a lower resistance of the switching element compared to the resistance of the switching element in the first switching state.

A high resistance can limit the flow of current through the switching element to such an extent that it can be neglected. If the resistance is reduced, a current flow through the switching element is allowed. This can be viewed as a switching process.

In one example, the switching element comprises a diode, wherein the diode is configured to transition from the first switching state to the second switching state upon reaching a forward voltage of the diode.

The switching element is configured here as a diode, which is operated in the flow direction or forward direction when the two coils are connected in series. The switchover from parallel to series connection can take place through the voltage difference between the first circuit branch and the second circuit branch. This is at least equal to the forward voltage of the diode. This means that a voltage below the forward voltage corresponds to a first switching state and a voltage equal to or higher than the forward voltage corresponds to the second switching state. The forward voltage corresponds to the threshold voltage. In particular, the term forward voltage means the voltage that can be read in the diode characteristic diagram when the apparently straight part is extended to the x-axis.

This has the technical advantage that the switching element can be easily manufactured and the switching process takes place automatically. The switching process of the switching element, which converts the parallel connection of the first circuit branch and the second circuit branch into the series connection of the first relay and the second relay, begins as soon as the voltage difference between the first circuit branch and the second circuit branch corresponds to at least the forward voltage of the diode. In addition, the additional voltage drop across the diode and the series resistor of the switching element in the circuit branch between the first circuit branch and the second circuit branch can further reduce the current in the series connection of the first relay and the second relay, so that the heat losses through the first and second excitation coils can also be reduced.

When using a diode as a switching element, the switching time is determined by the capacitance of the capacitors, i.e. the first capacitor and the second capacitor, with a fixed internal resistance and coil dimensioning of the relay. The switching time results from the voltage difference in the middle branch of the circuit. At the beginning this is equal to the applied total voltage, with a reactance of the capacitors of zero. By charging the capacitors, the amount of the initially negative voltage between the first circuit branch and the second circuit branch is reduced, that is to say towards zero. If the voltage becomes positive and greater than the forward voltage of the diode, the diode switches.

In one example, the switching element comprises at least one further diode and/or a series resistor to influence the point in time of the transition from the first switching state to the second switching state.

The switching time can be varied by several diodes in series and/or in combination with a series resistor for the diode between the first circuit branch and the second circuit branch. That is, the relay module can be adapted so that the switching element switches at a desired point in time, relative to the switching state of the relays. Due to the additional voltage drop across the diode and the resistor, the current in the series connection of the coils can be further reduced. The heat losses can be reduced. The series resistor can limit the diode current when the relays are switched off and the holding current, i.e. the operating current of the relay module in the holding state.

In one example, the switching element comprises a transistor, in particular a bipolar transistor or a field effect transistor, i.e., a metal-oxide-semiconductor field-effect transistor (MOSFET).

This has the technical advantage that the switching element is configured as a robust component with high switching accuracy and switching reliability.

In one example, the transistor is a PNP bipolar transistor or an NPN bipolar transistor.

This has the technical advantage that after the switching process has been completed in the series connection of the first and second excitation coils, a low excitation current flows. A PNP transistor can reduce the current in the series circuit by half compared to the parallel circuit. This effect can be increased with an NPN transistor and the current can thus be reduced further.

In one example, the transistor is a MOSFET transistor.

In addition, the transistor is de-energized during the switching process, so that the occurrence of power loss during the switching process on the switching element is avoided. By using blocking diodes, high switch-off currents can be avoided and voltage peaks can be assessed more precisely. Using a MOSFET saves more energy than using another transistor, since no current flows to the control terminal of the transistor. Voltage peaks on the coil when the transistor is switched off can also be avoided.

In one example, the transistor is preceded by an RC element and a voltage divider, by which RC element and voltage divider a time constant is defined.

This has the technical advantage that, by means of the time constant of the RC element, the switching point in time of the switching element can be matched to the point in time at which the armatures are fully drawn into the holding position, i.e. the relay module has assumed the holding state. For this purpose, the RC element has a third resistor and a third capacitor. The dimensions of the third resistor and the third capacitor are matched to the first capacitor and the second capacitor. A point in time at which the holding position is reached can thus be determined over the duration of the charging of the first capacitor and the second capacitor. By coordinating the dimensions of the RC element with regard to the ratio of the time constant of the RC element to the duration of the charging of the first capacitor and the second capacitor, coordination of the switching time of the switching element with the time of complete tightening of the armatures can be achieved. This has the technical advantage that voltage peaks at the second excitation coil are avoided.

In one example, the transistor is preceded by a controller, in particular a microcontroller, which is configured to determine a switching time of the transistor as a function of a measured current in the first circuit branch and/or the second circuit branch.

By means of a control, such as a microcontroller, a switching time can also be adapted at a later point in time, for example in an operation by reprogramming or setting the control. An external voltage pulse can be sent from the controller to the transistor, which leads to switching. The individual relay currents are measured, i.e. the currents through the relays.

In one example, the controller is configured to provide a switching voltage for switching the switching element when the measured current falls below a predetermined limit value, in particular when the measured current falls below a predetermined limit value in the first circuit branch or the second circuit branch, respectively.

The charging current of the capacitors is monitored here. If this falls to the specified limit value after a maximum, it can be assumed that the relays have successfully picked up the respective armature. The charging current is also at the same time the current that flows through the respective coil in the first circuit branch or the second circuit branch.

In one example, a first blocking diode is arranged between the first relay and the switching element to block a flow of current from the switching element to the first relay and a second blocking diode is arranged between the second relay and the switching element to block a flow of current from the second relay to the switching element, to limit a shutdown current.

The blocking diodes can prevent an undesired flow of current through the relay. In particular, a cutoff current can be limited in this case.

In one example, the relay module is a safety relay module to fulfill a safety-relevant function and wherein the first relay and the second relay are redundant relays.

A safety-relevant function can be a function in which the safety of a user is affected. For example, a user can be protected from an electric shock.

According to a second aspect, the object is solved by an arrangement with an electromagnetic relay module according to the above described type in an emergency stop switch or a protective door switch or a magnetic switch or with a light curtain.

As a result, the safety of the respective component can be kept high and, in addition, the power of the relay module can be reduced as described above.

### BRIEF DESCRIPTION OF THE DRAWINGS

Further examples of the principles described herein are explained with reference to the accompanying figures.

FIG. 1 shows an equivalent circuit diagram of a relay module according to an example of the disclosure;

FIG. 2 shows an equivalent circuit diagram of a relay module in accordance with a further example of the disclosure;

FIG. 3 shows an equivalent circuit diagram of a relay module according to a further example of the disclosure;

FIG. 4 shows an equivalent circuit diagram of a relay module according to a further example of the disclosure;

FIG. 5 shows an equivalent circuit diagram of a relay module according to a further example of the disclosure;

FIG. 6 shows an equivalent circuit diagram of a relay module according to a further example of the disclosure; and

FIG. 7 shows a schematic illustration of an arrangement with a relay mode according to an example of the disclosure.

### DETAILED DESCRIPTION

In the following detailed description, reference is made to the accompanying drawings, which form a part hereof, and in which there is shown, by way of illustration, specific examples in which the disclosure may be carried out. It goes without saying that other examples can also be used and structural or logical changes can be made without deviating from the concept of the present disclosure. The following detailed description is therefore not to be taken in a limiting sense. Furthermore, it is understood that the features of the various examples described herein can be combined with one another, unless specifically stated otherwise.

The aspects and examples are described with reference to the drawings, wherein like reference characters generally refer to like elements.

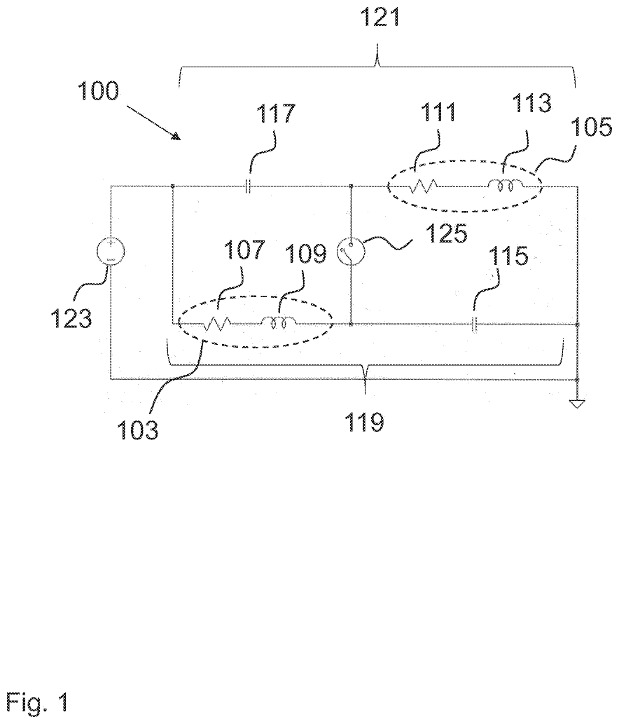

FIG. 1 shows an equivalent circuit diagram of a relay module 100 according to an example. The electromagnetic relay module 100 comprises a first relay 103 and a second relay 105. The first relay 103 comprises a first internal resistance 107 and a first coil 109. The first coil 109 is configured to generate a first magnetic field and to attract a first armature (not shown in the figures) by the first magnetic field. The second relay 105 comprises a second internal resistance 111 and a second coil 113. The second coil 113 is configured to generate a second magnetic field and to attract a second armature (also not shown in the figures) by the second magnetic field

If the first armature is attracted, the first relay 103 is in a holding state. If the second armature is attracted, the second relay 105 is in a holding state. If the first armature and the second armature are both attracted at the same time, the relay module 100 is in a holding state.

The relay module 100 has a first capacitor 115 and a second capacitor 117. The first capacitor 115 is connected in series with the first relay 103. The first capacitor 115 and the first relay 103 are arranged in a first circuit branch 119. The second capacitor 117 is connected in series with the second relay 105. The second capacitor 117 and the second relay 105 are arranged in a second circuit branch 121. The first circuit branch 119 and the second circuit branch 121 are arranged parallel to one another.

The relay module 100 comprises a voltage source 123. The voltage source 123 is a constant voltage source and is configured to output a constant voltage. This means that the voltage is regulated to a target value if fluctuations occur in the voltage provided. For example, the voltage source 123 provides a constant voltage of 12V. In a further example, the voltage source 119 provides another constant voltage, for example 24V. The first voltage branch 119 and the second voltage branch 121 are electrically connected to the voltage source 123.

By applying the constant voltage by the voltage source 123, the first capacitor 115 and the second capacitor 117 are charged. By charging the first capacitor 115, a first charging current flows through the first relay 103. By charging the second capacitor 115, a second charging current flows through the second relay 103.

The first capacitor 115 is dimensioned such that the first charging current is suitable for causing a magnetic flow through the first coil and thus a corresponding magnetic field that is suitable for fully attracting the first armature of the first relay 103 and thus to move the first relay 103 into the holding position. The second capacitor 115 is dimensioned such that the second charging current is suitable for causing a magnetic flow through the second coil and thus a corresponding magnetic field which is suitable for fully attracting the second armature of the second relay 103 and thus to move the second relay 103 into the holding position. Both capacitors 115, 117 are dimensioned so that the charging current is sufficient to achieve an initial flow in the coils 109, 113 used, which in each case generates a magnetic field to attract the corresponding armature.

The relay module 100 comprises a switching element 125. The switching element 125 is arranged between the first circuit branch 119 and the second circuit branch 121 such that the switching element 125 is arranged between the first relay 103 and the first capacitor 115 and between the second capacitor 119 and the second relay 105. The switching element 125 has a first switching state and a second switching state.

In the first switching state of the switching element 125, the switching element 125 is open or has a high resistance to prevent a current flow from the first relay 103 to the second relay 105 through the switching element 125. Preventing can be understood to mean that the flow of current is interrupted or limited to such an extent that it is negligible in the context of the usual application of the relay module 100. In the second switching state of the switching element 125, the first circuit branch 119 is electrically connected to the second circuit branch 121 by the switching element 125, so that an electrical current can flow through the switching element 125. The switching element 125 is closed here or has a low resistance.

When the switching element 125 is switched to the second switching state, the parallel connection of the first and second circuit branches 101, 102 is switched into a series connection of the first and second relay 103, 105. That is, by the switching element 125, the first relay 103 and the second relay 105 are electrically connected in series in the second switching state of the switching element 125. The switching element 125 is configured to switch from the first switching state to the second switching state when the relay module 100 reaches the holding state, that is, as soon as the first armature and the second armature are attracted.

The first capacitor 115 and the second capacitor 117 are high-resistive at the time of switching the switching element 125 and are not part of the series connection of the first relay 103 and the second relay 105. Thus, they ensure that a primary current path runs along the series connection of the first relay 103 and the second relay 105.

When the parallel connection of the first and second circuit branches 101, 102 is switched over to the series connection of the first relay 103 and the second relay 105, the total resistance of the first relay 103 and the second relay 105 is increased. This results in a reduction in the coil currents at constant voltage, which is ensured by the voltage source, and an associated reduction in the magnetic flow and the magnetic fields of the first relay 103 and the second relay 105, whereby the power dissipation of the relay module 100 can be reduced.

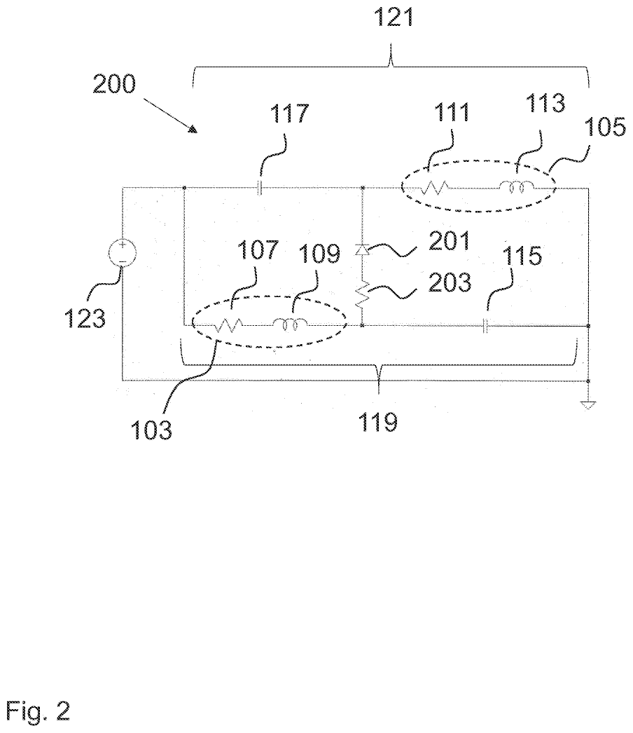

FIG. 2 shows an equivalent circuit diagram of a relay module 200 according to a further example. Here, the switching element 125 comprises a diode 201 and a series resistor 203 connected in series upstream of the diode 201. By means of the diode 201 and the series resistor 203 connected in series, the time of the switching process of the switching element 125 at which the parallel connection of the first circuit branch 119 and the second circuit branch 121 is transferred into the series connection of the first relay 103 and the second relay 105, can be coupled to the voltage difference between the first circuit branch 119 and the second circuit branch 121. The switching element 125 accordingly switches as soon as the voltage difference between the first circuit branch 119 and the second circuit branch 121 corresponds to the forward voltage of the diode 201.

In a further example (not shown in the figures), the switching element 125 comprises a plurality of diodes connected in series. In a further example, the switching element 125 additionally comprises a plurality of series resistors connected in series. As a result, the point in time of the switching process of the switching element 125 can be changed in comparison to the circuit with a single diode 201 and a single series resistor 203.

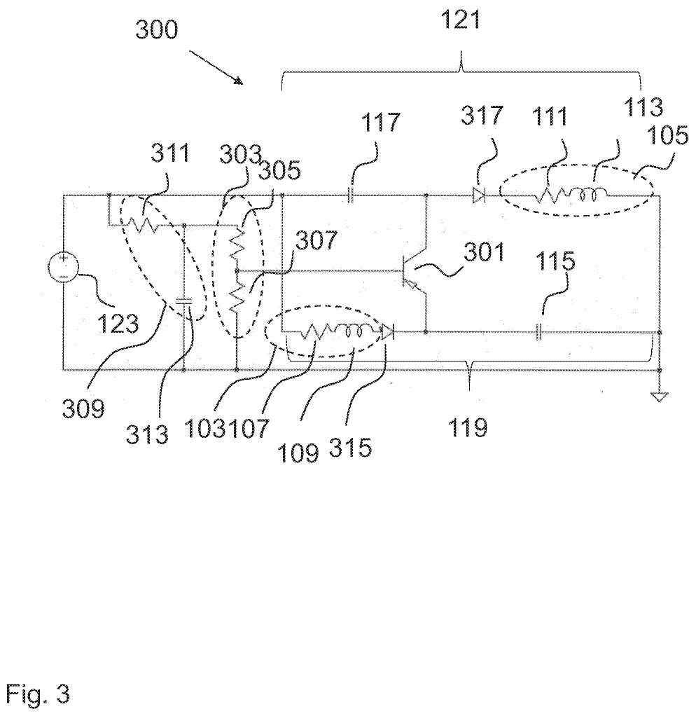

FIG. 3 shows an equivalent circuit diagram of a relay module 300 according to a further example. In this case, the switching element 125 comprises a transistor 301. In the example shown, the transistor 301 is a PNP bipolar transistor. In a further example, it is a different transistor, in particular an NPN bipolar transistor.

The transistor 301 is connected via the base connection to a voltage divider 303, which comprises a first resistor 305 and a second resistor 307. The transistor 301 is additionally electrically connected via the base connection to an RC element 309, which comprises a third resistor 311 and a third capacitor 313. Via the dimensioning of the RC element 309 and the first resistor 305 and the second resistor 307 of the voltage divider 303, the switching instant of the transistor 301 can be coordinated with the instant of the complete tightening of the first armature and the second armature, i.e., the switching instant of the switching element 125 can be coupled to reaching the holding state of the relay module 100, in particular it is coupled to that.

In the example shown in FIG. 3, the first circuit branch 119 additionally comprises a first blocking diode 315 and the second circuit branch 121 comprises a second blocking diode 317. The first blocking diode 315 and the second blocking diode 317 are arranged between the first relay 103 and the first capacitor 115 or the second capacitor 117 and the second relay 105, respectively, such that the first blocking diode 315 and the second blocking diode 317 are parts of the series connection with the first relay 104 and the second relay 105 when the transistor is in the conductive state and the switching element 103 is thus in the second switching state. In a further example, one or both blocking diodes 115, 117 can be omitted.

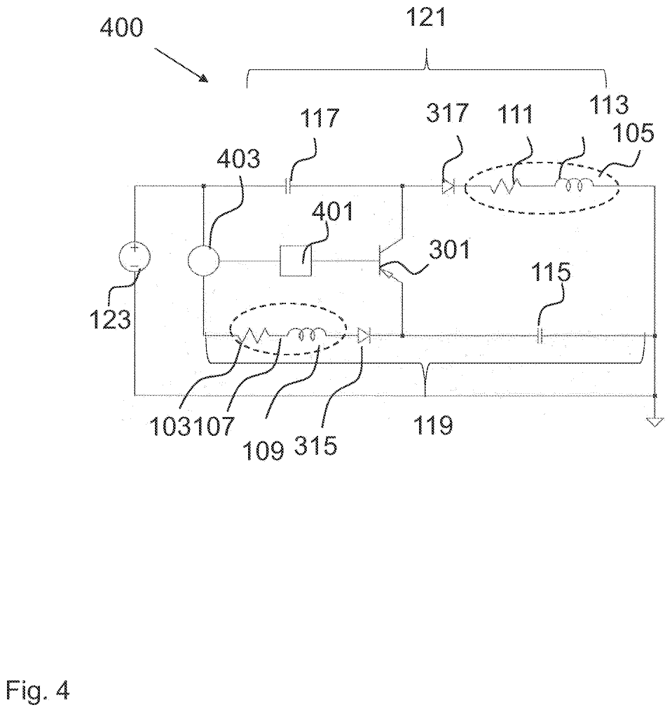

FIG. 4 shows an equivalent circuit diagram of a relay module 400 according to a further example. Here, the switching element 125 is the transistor 301, as described with respect to FIG. 3. The first circuit branch 119 also comprises the first blocking diode 315 and the second circuit branch 121 comprises the second blocking diode 317.

However, instead of the voltage divider 303 and the RC element 309 for controlling the switching time of the transistor 301, a controller 401, in particular a microcontroller, is provided which is connected to the base terminal of the transistor 301 and is configured to send a switching signal to the base terminal of the transistor 301 via an output of the controller. As a result, the switching element 125, i.e. the transistor 301, can be transferred from the first switching state to the second switching state.

To determine the point in time for switching over the switching element 125, the circuit according to the example shown in FIG. 4 comprises a current measuring device 403. The current measuring device 403 comprises a current measuring resistor (not shown). In a further example, the current is measured in a contactless manner by means of a clamp meter.

If the measured current reaches a limit value stored in the controller, the controller 401 generates a control signal and sends the control signal to the transistor 301 via an output of the controller 401 to switch the transistor 301 and thus to move the switching element 125 from the first switching state to the second switching state.

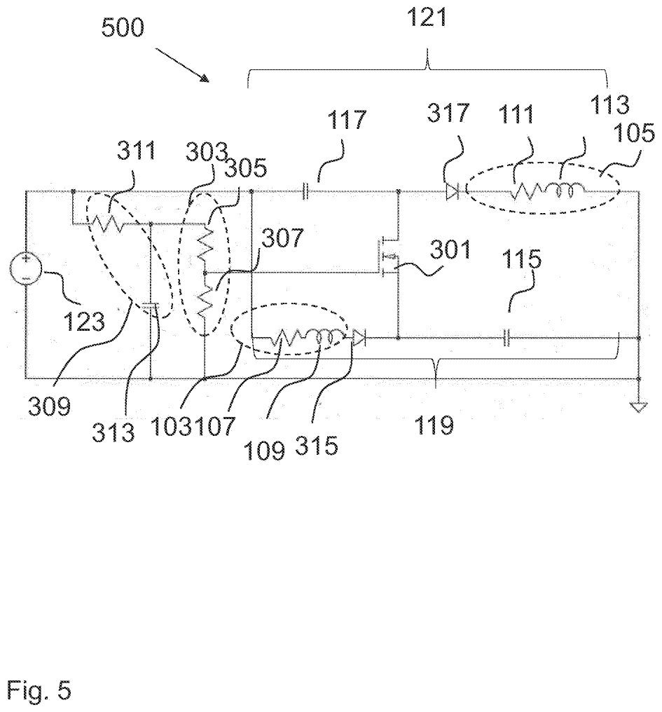

FIG. 5 shows an equivalent circuit diagram of a relay module 500 according to a further example. The relay module 500 according to the example of FIG. 5 corresponds to the relay module 300 of the example of FIG. 3. However, the transistor 301 is a field-effect transistor, in particular a metal-oxide-semiconductor field-effect transistor, abbreviated as MOSFET.

The voltage divider 303 and the RC element 309 are connected to the gate terminal of the MOSFET to adapt the switching time of the switching element 125 to the transition of the relay module 100 into the holding state.

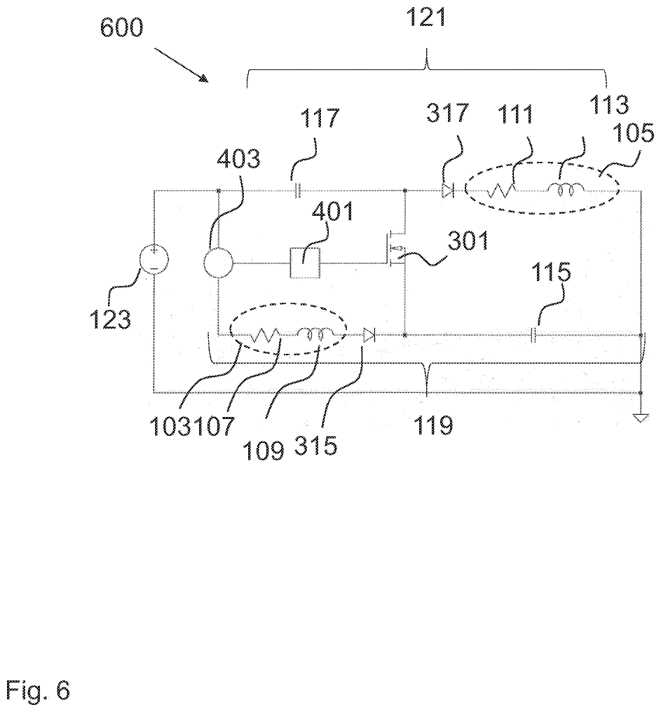

FIG. 6 shows an equivalent circuit diagram of a relay module 600 in accordance with a further example. The relay module 600 according to the example of FIG. 6 corresponds to the relay module 400 of the example of FIG. 4. However, the transistor 301 is a field effect transistor, in particular a metal-oxide-semiconductor field effect transistor, abbreviated as MOSFET.

The controller 401 is connected to the gate terminal of the MOSFET to adapt the switching time of the switching element 125 to the transition of the relay module 100 into the holding state.

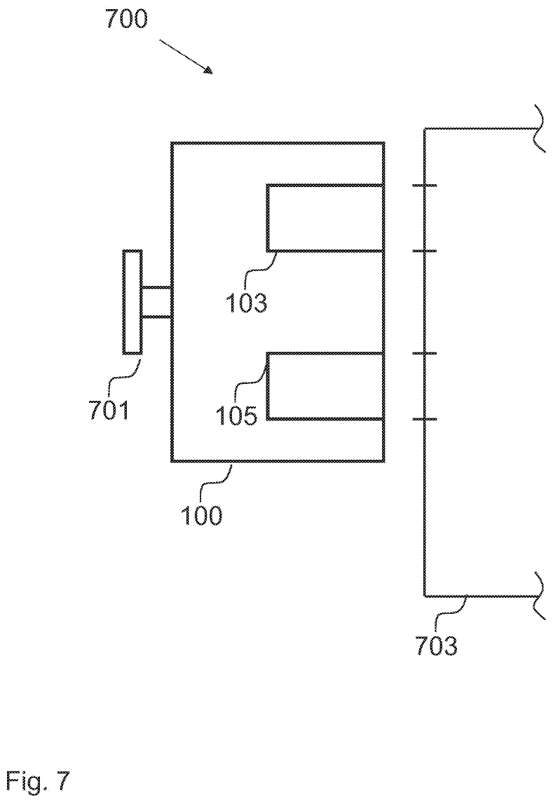

FIG. 7 shows an arrangement 700. The arrangement 700 comprises the relay module 100 and an emergency stop switch 701. In a further example, one of the relay modules 200, 300, 400, 500 or 600 is installed. In a further example, the arrangement 700 comprises the relay module 100 and a protective door switch or a magnetic switch or a light grid.

The relay module 100 is arranged such that the relay module 100 can fulfill a safety-relevant function of the arrangement 700. In the example shown, the relay module 100 is actuated by the emergency stop switch 701 to interrupt a circuit 703. The circuit 703 is partially shown in FIG. 7 for reasons of clarity. In particular, the circuit 703 can comprise further components in parts not shown or can be connected to machines. In this case, the first relay 103 and the second relay 105 interrupt the circuit 703 redundantly. This also ensures that the circuit 703 is interrupted if one of the two relays 103, 105 should have a malfunction, such as a jamming armature.

### LIST OF REFERENCE NUMBERS

100, 200, 300 relay module
400, 500, 600 relay module
103 first relay
105 second relay
107 first internal resistance
109 first inductor/coil
111 second internal resistance
113 second inductor/coil
115 first capacitor
117 second capacitor
119 first circuit branch
121 second circuit branch
123 voltage source
125 switching element
201 diode
203 series resistor
301 transistor
303 voltage divider
305 first resistance
307 second resistance
309 RC element
311 third resistance
313 third capacitor
315 first blocking diode
317 second blocking diode
401 control
403 current measuring device
700 arrangement
701 emergency stop switch
703 circuit

What is claimed is:

1. An electromagnetic relay module, comprising:
a first circuit branch comprising a first capacitor and a first relay connected in series with the first capacitor,
a second circuit branch comprising a second capacitor and a second relay connected in series with the second capacitor,
a switching element which is arranged between the first circuit branch and the second circuit branch and comprises a first switching state and a second switching state,
wherein in the first switching state of the switching element the first circuit branch and the second circuit branch are arranged in a parallel connection, and wherein in the second switching state of the switching element the first relay and the second relay are arranged in a series connection, and
wherein the switching element is configured to change from the first switching state to the second switching state in the switch-on process of the electromagnetic relay module.

2. The electromagnetic relay module of claim 1, wherein the electromagnetic relay module comprises a holding position in which a first armature is attracted by the first relay and in which a second armature is attracted by the second relay, and wherein the switching element is configured to change from the first switching state to the second switching state as soon as the electromagnetic relay module has taken a stop position.

3. The electromagnetic relay module of claim 2, wherein the first capacitor is configured to provide a first charging current to the first relay in the first switching state of the switching element, and the second capacitor is configured to provide a second charging current to the second relay in the first switching state of the switching element, the first charging current being suitable for causing an attraction and holding of the first armature, and wherein the second charging current is suitable to cause an attraction and holding of the second armature.

4. The electromagnetic relay module of claim 3, wherein the electromagnetic relay module is connected to a voltage source which is configured to provide a constant voltage, wherein the first circuit branch and the second circuit branch is connected to the voltage source.

5. The electromagnetic relay module claim 4, wherein the first capacitor provides the first charging current and the second capacitor provides the second charging current, when the constant voltage is applied to the first circuit branch and to the second circuit branch.

6. The electromagnetic relay module of claim 1, wherein the first switching state of the switching element comprises a higher resistance of the switching element compared to a resistance of the switching element in the second switching state and wherein the second switching state of the switching element comprises a lower resistance of the switching element compared to a resistance of the switching element in the first switching state.

7. The electromagnetic relay module of claim 6, wherein the switching element comprises a diode, wherein the diode is configured to transition from the first switching state to the second switching state upon reaching a forward voltage of the diode.

8. The electromagnetic relay module of claim 7, wherein the switching element comprises a second diode, a series resistor, or a combination thereof.

9. The electromagnetic relay module of claim 6, wherein the switching element comprises a transistor, and wherein the transistor comprises a bipolar transistor or a metal-oxide-silicon field-effect transistor (MOSFET).

10. The electromagnetic relay module of claim 9, wherein the transistor is preceded by an RC element and a voltage divider, by which a time constant is defined.

11. The electromagnetic relay module of claim 9, wherein the transistor is preceded by a controller which is configured to determine a switching time of the transistor as a function of a measured current in the first circuit branch or the second circuit branch.

12. The electromagnetic relay module of claim 11, wherein the controller is configured to provide a switching voltage for switching the switching element when the measured current falls below a predetermined limit value.

13. The electromagnetic relay module of claim 12, wherein a first blocking diode is arranged between the first relay and the switching element to block a flow of current from the switching element to the first relay and a second blocking diode is arranged between the second relay and the switching element to block a flow of current from the second relay to the switching element.

14. The electromagnetic relay module of claim 1, wherein the electromagnetic relay module is a safety relay module configured to fulfill a safety-relevant function and wherein the first relay and the second relay are redundant relays.

15. The electromagnetic relay module of claims 1, wherein the electromagnetic relay module is included in an emergency stop switch or a protective door switch or a magnetic switch or with a light curtain.

16. The electromagnetic relay module of claim 11, wherein the controller comprises a microcontroller.

17. The electromagnetic relay module of claim 1, wherein the electromagnetic relay module comprises a holding position in which an armature is attracted by the first relay, wherein the switching element is configured to change from the first switching state to the second switching state as soon as the electromagnetic relay module has taken a stop position.

18. The electromagnetic relay module of claim 17, wherein the first capacitor is configured to provide a charging current to the first relay in the first switching state of the switching element, the charging current being suitable for causing an attraction and holding of the armature.

19. The electromagnetic relay module of claim 1, wherein the electromagnetic relay module comprises a holding position in which an armature is attracted by the second relay, wherein the switching element is configured to change from the first switching state to the second switching state as soon as the electromagnetic relay module has taken a stop position.

20. The electromagnetic relay module of claim 19, wherein the second capacitor is configured to provide a charging current to the second relay in the first switching state of the switching element, the charging current suitable to cause an attraction and holding of the armature.
